(19) United States
(12) Patent Application Publication
(10) Pub. No.: US 2007/0282803 A1
(43) Pub. Date: Dec. 6, 2007

(54) Methods and systems for inventory policy generation using structured query language

(75) Inventors: Mateen Asghar, Quincy, MA (US); Kaan Kudsi Katircioglu, Yorktwon Heights, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/445,163

(22) Filed: Jun. 2, 2006

(51) Int. Cl. G06F 17/30

(52) U.S. Cl. 707/3

(57) ABSTRACT

Methods and systems for generating a business policy, include receiving a query in a structured query language to generate a business policy, and optimizing the business policy using a structured query language program.

### BACKGROUND OF THE INVENTION

1. Field of the Invention

The present invention generally relates to inventory management. In particular, the present invention relates to methods and systems for inventory policy generation using structured query language (SQL).

2. Description of the Related Art

There are numerous published works in inventory management as it has been a well established academic discipline and industrial practice. Some examples of classical textbooks include Production and Operations Management (Tersine Richard, J., North Holland, N.Y., 1980), Production and Operations Analysis (Nahmias Steven, McGraw Hill 2001), Introduction to Operations Research (Hillier F. S., G. J. Lieberman, Holden-Day, 1980), Production and Inventory Management (Hax A. C., Dan Candea, Prentice-Hall, 1984), and Analysis of Inventory Systems (G. Hadley, T. M. Whitin, Prentice Hall 1963).

There are many academic papers that are published in the last few decades. Some classical papers include Studies in Mathematical Theory of Inventory and Production (Arrow, K. J., S. Karlin and H. Scarf, Stanford University Press, California, 1958), Analytical Approximations for (s,S) inventory Policy Operating Characteristics (Ehrhart, R., Naval Research Logistics Quarterly, 28,2, p 255-266, 1981), Power Approximation for Computing (s,S) Inventory Policies (Ehrhardt, R., Management Science, 25, p 777-786, 1979), Evaluating the Effectiveness of a New Method for Computing Approximately Optimal (S,S) Inventory Policies (Freeland, J. R. and E. L. Porteus, Operations Research, 28, 2, p 353-366, 1980), The Dynamic Inventory Problem with Unknown Distribution of Demand (Iglehart, D. L., Management Science, 10, p 429-440, 1964), The Optimality of (s,S) Policies in The Dynamic Inventory Problem, (Scarf Herbert, in Mathematical Methods in The Social Sciences, Ed. Arrow, Karlin, Suppes, Stanford University Press, p 196-202, 1959. Computing Optimal (s,S) Inventory Policies (Topkis, Donald M., Management Science, 15, 3, p 160-176, 1968), Finding Optimal (s,S) Policies Is About As Simple As Evaluating a Single Policy (Zheng, Y. S., A. Federgruen, Operations Research, 39, 4, p 654-665, 1992).

These papers with the exception of Eharhardt's papers all have algorithms that can be used to calculate the optimal inventory policies or performance measures such as average inventory and backlogging costs, service levels, etc. Virtually all of these algorithms with the exception of the ones given by Ehrhardt need iterative methods to do the calculations and hence are not suitable for limited functionality of SQL.

Although Ehrhardt's formulas can be used in SQL, they are limited to cost minimization problems with no service constraints and (s,S) inventory policy.

However, none of the prior art attempts to develop a method to calculate parameters used in inventory management enables one to use SQL functions in order to perform these calculations.

Inventory optimization generally requires coding optimization algorithms in programming languages such as C, C++, Java, etc. However, codes written in such languages cannot be invoked easily and seamlessly in a structured query language. Therefore, integrating an inventory optimization solution with reporting tools that have strong integration capabilities is a cumbersome task. The existing solutions typically require flat file interfaces, which are not seamless. They are sold as separate software solutions and bring the entire set of software management issues with them. Companies that already have enterprise resource planning (ERP) systems and reporting systems that use query languages can use this methodology to do inventory optimization without any need to purchase additional software.

Another problem is that in structured query language it is impossible to perform algorithmic do-loops. In other words, a structured query language cannot perform iterative calculations.

Rather, these iterative calculations have had to be performed in batch mode. Therefore, a user is required to wait until the batch run is complete and the resulting data is made available. This is not convenient for users who wish to do many sequential analyses of alternative scenarios in an attempt to determine an optimum business policy.

### SUMMARY OF THE INVENTION

In view of the foregoing and other exemplary problems, drawbacks, and disadvantages of the conventional methods and structures, an exemplary feature of the present invention is to provide a method and system in which inventory policies are optimized using a structured query language program.

In a first exemplary aspect of the present invention, a method of generating a business policy includes receiving a query in a structured query language to generate a business policy, and optimizing the business policy using a structured query language program.

In a second exemplary aspect of the present invention, a system for generating a business policy includes an enterprise resource planning system, a data extractor for the enterprise resource planning system, and a structured query language engine including a structured query language program that includes an objective function for generating the business policy.

In a third exemplary aspect of the present invention, a program embodied in a computer readable medium executable by a digital processing unit includes instructions for receiving a query in a structured query language to generate a business policy, and instructions for generating the business policy using a structured query language program in the digital processing unit.

An exemplary method of the invention makes coding of inventory algorithms possible in a query language using basic mathematical functions that are typically available is a query language. One exemplary method uses innovative approximations to complicated functions and, therefore, eliminates the need for writing complex algorithms for calculating optimal inventory policies. The advantage is that these functions can be coded in a query language and, therefore, makes it possible to do inventory optimization in query languages.

The invention makes it possible to perform inventory optimization using a structured query language in any database.

A structured query language is very limited in its mathematical abilities. For example, it is not possible to write looping/iterative algorithms using a structured query language. Rather, all calculations must be performed in a linear manner. Therefore, a structured query language is not designed to do inventory optimization. A structured query language is merely designed to facilitate making and solving queries.

The inventors discovered a method and system that enables optimization to be performed in a structured query language.

The inventors discovered approximation functions which enable optimization to be performed using a structured query language. These approximation functions may be encoded in a structured query language.

An exemplary embodiment of the present invention optimizes inventory using a structured query language.

An exemplary embodiment of the present invention may optimize using any platform that uses a structured query language and in any business application areas where optimization may be performed. The present invention may be implemented using, for example, a DB2 universal database platform by International Business Machines, a MySQL open source structured query language database platform, a PostgreSQL open source structured query language database platform, an Oracle® database platform, a Microsoft® structured query language database platform, and the like.

An exemplary embodiment of the present invention may optimize business policies in any number of areas, such as, for example, customer relationship management, procurement, revenue management, supplier relationship management, and the like.

The invention takes a complicated and advanced algorithm and approximates the objective function of this algorithm using simple functions and encoding the approximated objective function in a structured query language.

The process of approximating complex algorithms is known. The invention lays in the assembling of these approximating functions in a structured query language.

An exemplary embodiment of the present invention optimizes a business performance metric, such as, for example, cost, profit, revenue, customer satisfaction, and the like. In general, the present invention may optimize any business metric at any level.

An exemplary embodiment of the present invention saves time in performing complex calculations. Complex calculations take time to run, which eliminates the possibility of real time interactive analysis with the users. As a result, decisions take much longer and may result in lost business opportunities.

An exemplary embodiment of the present invention may simplify the information technology architecture that is required to perform complex analyses. Algorithms can be coded in languages such as C, or C++ and data feeds can be created from databases, back and forth. However, this kind of architecture is complicated and, therefore, costly to develop, implement, and maintain the systems. This exemplary embodiment codes approximations of these functions into a structured query language, which solves the above-identified problems. In this manner, this exemplary embodiment requires only very simple architectures, which provides significant savings in costs in all stages of development and implementation

These and many other advantages may be achieved with the present invention.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an exemplary inventory optimization environment 100 in which the present invention may be used;

FIG. 2 illustrates a flowchart 200 for an exemplary structured query language engine in accordance with the present invention;

FIG. 3 illustrates a flowchart 300 for an exemplary system for processing “what if” queries in accordance with the present invention;

FIG. 4 illustrates an exemplary hardware/information handling system 400 for incorporating the present invention therein; and

FIG. 5 illustrates a program embodied in a computer readable medium executable by a digital processing unit according to the present invention.

### DETAILED DESCRIPTION OF EXEMPLARY EMBODIMENTS OF THE INVENTION

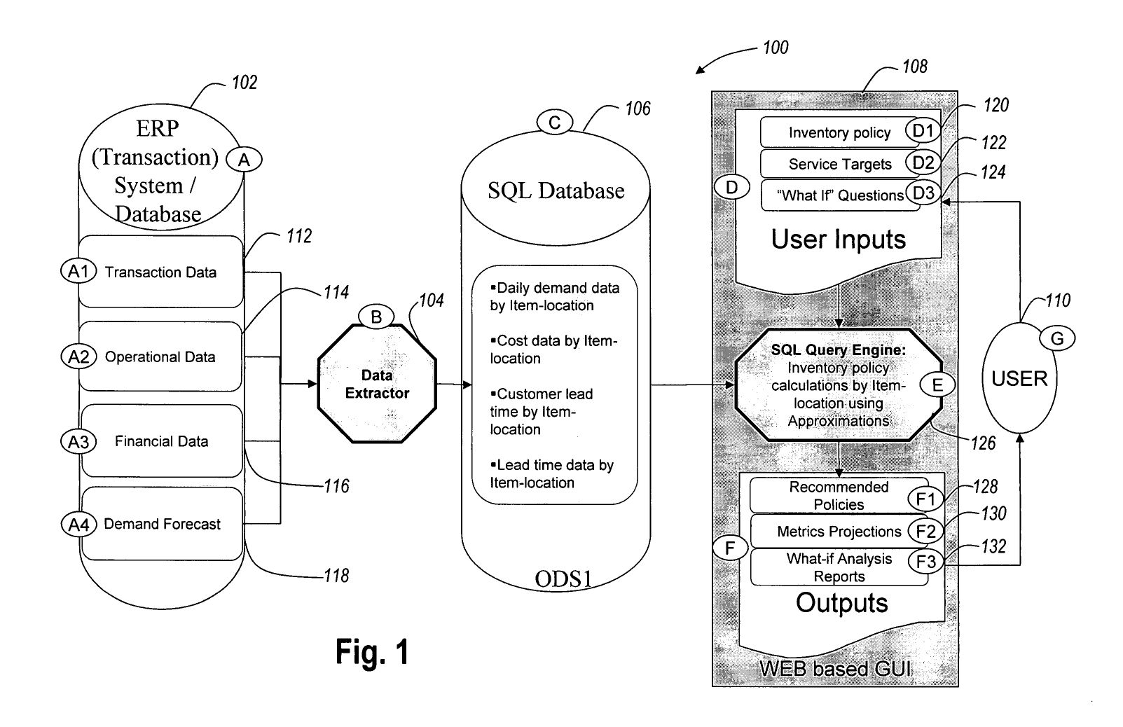

Referring now to the drawings, and more particularly to FIGS. 1-5, there are shown exemplary embodiments of the method and structures of the present invention.

Inventory optimization typically involves determining how much “safety stock” an organization should hold at a given location. A safety stock is the amount of inventory that should be on hand to protect the organization against uncertainty in demand and supply. The safety stock may include a product that the organization is selling, materials that may be used for manufacturing such a product, and/or materials that may be used during the course of business activity.

Holding too much inventory means that resources are wasted. Holding too little inventory means that the organization will be unable to satisfy demand and the sales of the organization may suffer. Therefore, organizations are very interested in determining the correct amount of safety stock.

Conventionally, the safety stock has been determined using a complicated algorithm. An exemplary embodiment provides a simple function which approximates the complicated algorithm that may be encoded into a structured query language.

An instruction in a structured query language approximates an optimum safety stock level.

An instruction in a structured query language approximates an optimal inventory policy. An optimal inventory policy may have several parameters such as, for example, safety stock, the order level, lot size, and the like. This optimal inventory policy may be represented using a complex algorithm. However, these complex algorithms may not be encoded into a structured query language.

An exemplary embodiment of the present invention enables an optimal inventory policy to be implemented in a structured query language using an approximation function for the solution to the policy.

While the above-described inventory optimization system addresses a portion of the inventory optimization problems, one of ordinary skill in the art understands that the present invention may be extended to cover additional inventory optimization problems and still form a part of the present invention.

These additional problems merely need approximate functions to be developed by those of ordinary skill in the art. Such approximate functions may then be implemented by the present invention in a structured query language.

FIG. 1 illustrates an exemplary inventory optimization environment 100 in which the present invention may be used. The system 100 includes an enterprise resource planning (ERP) system 102, a data extractor 104, a structured query language database 106, and a Web-based graphical user interface (GUI) 108, with which a user 110 interacts with the system 100.

The enterprise resource planning system 102 includes sales transaction data. Enterprise resource planning system 102 typically operates using relational databases such as a DB2 database, an Oracle database, or the like. Each of the databases in the enterprise resource planning system 102 works in cooperation with a corresponding data extractor 104 with which data may be extracted, manipulated, stored, and the like.

The enterprise resource planning system 102 includes transaction data 112. Transaction data 112 may include sales transaction data with detailed order information for each customer order. The transaction data 112 may have data about, for example, the date of origination of a customer order, the date that shipment is requested, what quantity of each item is requested, customer information, customer location information, stocking location information, price, and the like. Table 1 illustrates an exemplary transaction database 112, which identifies Item, Stocking Facility, Order Quantity (ORQ), Order entry date (OED), and Requested ship date (RSD).

TABLE 1
Sales data by item-stocking facility

| | | | | | Customer |
|---|---|---|---|---|---|
| | | Order | | Requested | lead time |
| | Stocking | Quantity | Order entry date | ship date | (CLT[i] = |
| Item | Facility | (ORQ[I]) | (OED[i]) | (RSD[i]) | RSD[i] − OED[i]) |
| 00001 | 000LOC1 | 250 | Nov. 09, 2004 | Jan. 14, 2005 | Mar. 06, 2000 |
| 00001 | 000LOC1 | 480 | Nov. 12, 2004 | Jan. 14, 2005 | Mar. 03, 2000 |
| 00001 | 000LOC1 | 40 | Jan. 11, 2005 | Jan. 18, 2005 | Jan. 07, 2000 |
| 00001 | 000LOC1 | 5 | Jan. 13, 2005 | Jan. 20, 2005 | Jan. 07, 2000 |
| 00001 | 000LOC1 | 300 | Nov. 24, 2004 | Jan. 21, 2005 | Feb. 27, 2000 |
| 00001 | 000LOC1 | 504 | Dec. 16, 2004 | Jan. 21, 2005 | Feb. 05, 2000 |
| 00001 | 000LOC1 | 2 | Jan. 14, 2005 | Jan. 28, 2005 | Jan. 14, 2000 |
| 00001 | 000LOC1 | 504 | Dec. 24, 2004 | Feb. 02, 2005 | Feb. 09, 2000 |
| 00001 | 000LOC2 | 500 | Dec. 02, 2004 | Feb. 09, 2005 | Mar. 09, 2000 |
| 00001 | 000LOC2 | 10 | Feb. 02, 2005 | Feb. 11, 2005 | Jan. 09, 2000 |
| 00001 | 000LOC2 | 504 | Jan. 07, 2005 | Feb. 21, 2005 | Feb. 14, 2000 |
| 00001 | 000LOC2 | 20 | Feb. 01, 2005 | Mar. 03, 2005 | Jan. 30, 2000 |
| 00001 | 000LOC2 | 150 | Dec. 21, 2004 | Mar. 11, 2005 | Mar. 20, 2000 |
| 00001 | 000LOC2 | 350 | Jan. 06, 2005 | Mar. 11, 2005 | Mar. 04, 2000 |
| 00001 | 000LOC1 | 300 | Jan. 24, 2005 | Mar. 17, 2005 | Feb. 21, 2000 |
| 00001 | 000LOC1 | 200 | Feb. 07, 2005 | Mar. 22, 2005 | Feb. 12, 2000 |
| 00001 | 000LOC1 | 504 | Feb. 22, 2005 | Apr. 01, 2005 | Feb. 07, 2000 |
| 00002 | 000LOC1 | 10 | Mar. 25, 2005 | Apr. 25, 2005 | Jan. 31, 2000 |
| 00002 | 000LOC1 | 200 | Mar. 18, 2005 | May 10, 2005 | Feb. 22, 2000 |
| 00002 | 000LOC1 | 42 | Apr. 25, 2005 | May 13, 2005 | Jan. 18, 2000 |
| 00002 | 000LOC1 | 300 | Feb. 16, 2005 | May 16, 2005 | Mar. 29, 2000 |
| 00002 | 000LOC1 | 200 | Apr. 12, 2005 | May 23, 2005 | Feb. 10, 2000 |
| 00002 | 000LOC2 | 504 | Apr. 13, 2005 | May 23, 2005 | Feb. 09, 2000 |
| 00002 | 000LOC2 | 300 | Mar. 18, 2005 | Jun. 01, 2005 | Mar. 15, 2000 |
| 00002 | 000LOC2 | 501 | Apr. 22, 2005 | Jun. 14, 2005 | Feb. 22, 2000 |
| 00002 | 000LOC2 | 100 | Apr. 22, 2005 | Jun. 21, 2005 | Feb. 29, 2000 |
| 00002 | 000LOC2 | 110 | Apr. 19, 2005 | Jul. 04, 2005 | Mar. 16, 2000 |
| 00002 | 000LOC2 | 300 | Jun. 24, 2005 | Jul. 14, 2005 | Jan. 20, 2000 |
| 00002 | 000LOC3 | 504 | Jun. 14, 2005 | Jul. 15, 2005 | Jan. 31, 2000 |
| 00002 | 000LOC3 | 18 | Jun. 23, 2005 | Jul. 28, 2005 | Feb. 04, 2000 |
| 00002 | 000LOC3 | 230 | Jun. 24, 2005 | Aug. 10, 2005 | Feb. 16, 2000 |
| 00002 | 000LOC3 | 100 | Jul. 11, 2005 | Aug. 24, 2005 | Feb. 13, 2000 |
| 00002 | 000LOC3 | 39 | Jul. 26, 2005 | Aug. 24, 2005 | Jan. 29, 2000 |
| 00002 | 000LOC3 | 30 | Jul. 15, 2005 | Sep. 01, 2005 | Feb. 17, 2000 |
| 00002 | 000LOC3 | 100 | Jul. 26, 2005 | Sep. 06, 2005 | Feb. 11, 2000 |
| 00002 | 000LOC3 | 496 | Jul. 26, 2005 | Sep. 07, 2005 | Feb. 12, 2000 |
| 00002 | 000LOC3 | 504 | Aug. 09, 2005 | Sep. 09, 2005 | Jan. 31, 2000 |

The enterprise resource planning system 102 also includes operational data 114. Operational data 114 may include information for an item-location pair or stock keeping unit (SKU). The operational data 114 includes, for example, information about the inventory on hand, and on order, target service level, safety stock policy, various lead time data, and lot size data.

Tables 2-4 illustrate exemplary operational data. Table 2 includes material data and inventory and customer service data. The material data includes item and stocking facility data. The customer service data includes inventory position (IP), policy (POLICY), and service target data (TSERVICE).

TABLE 2
Inventory and customer service data by item-stocking facility

| | | Inventory | | |
|---|---|---|---|---|
| | Stocking | Position (units) | Policy | Service Target |
| Item | Facility | (IP) | (POLICY) | (TSERVICE) |
| 00001 | 000LOC1 | 495 | FRT | 95.0% |
| 00002 | 000LOC1 | 2,771 | PNS | 97.0% |
| 00003 | 000LOC1 | 3,912 | OTDR | 99.0% |
| 00004 | 000LOC1 | 8,028 | PMAX | 95.0% |
| 00005 | 000LOC1 | 9,294 | CMIN | 97.0% |
| 00006 | 000LOC1 | 4,137 | PNS | 99.0% |
| 00007 | 000LOC1 | 1,771 | OTDC | 95.0% |
| 00008 | 000LOC1 | 5,830 | PMAX | 97.0% |
| 00001 | 000LOC2 | 3,508 | CMIN | 99.0% |
| 00002 | 000LOC2 | 5,494 | PNS | 95.0% |
| 00003 | 000LOC2 | 5,588 | OTDR | 97.0% |
| 00004 | 000LOC2 | 9,053 | PMAX | 99.0% |
| 00005 | 000LOC2 | 4,022 | CMIN | 97.0% |
| 00006 | 000LOC2 | 7,037 | PNS | 99.0% |
| 00007 | 000LOC3 | 9,210 | OTDR | 95.0% |
| 00008 | 000LOC3 | 4,167 | PMAX | 97.0% |
| 00001 | 000LOC3 | 7,011 | PNS | 99.0% |
| 00002 | 000LOC3 | 9,388 | OTDR | 95.0% |
| 00003 | 000LOC3 | 5,285 | PMAX | 95.0% |
| 00004 | 000LOC3 | 6,963 | CMIN | 97.0% |

TABLE 3
Lot size data by item-stocking facility

| | | | Minimum lot | | |
|---|---|---|---|---|---|
| | Stocking | Fixed lot size | size increment | Maximum Lot | Minimum Lot |
| Item | Facility | (QFIX) | (QUNIT) | Size (QMAX) | Size (QMIN) |
| 00001 | 000LOC1 | 1,000 | 500 | 10,000 | 2,500 |
| 00002 | 000LOC1 | 1,000 | 500 | 10,000 | 2,500 |
| 00003 | 000LOC1 | 1,000 | 500 | 10,000 | 2,500 |
| 00004 | 000LOC1 | 1,000 | 500 | 10,000 | 2,500 |
| 00005 | 000LOC1 | 1,000 | 500 | 10,000 | 2,500 |
| 00006 | 000LOC1 | 1,000 | 500 | 10,000 | 2,500 |
| 00007 | 000LOC1 | 1,000 | 500 | 10,000 | 2,500 |
| 00008 | 000LOC1 | 2,000 | 500 | 10,000 | 2,500 |
| 00001 | 000LOC2 | 2,000 | 500 | 10,000 | 2,500 |
| 00002 | 000LOC2 | 2,000 | 500 | 10,000 | 2,500 |
| 00003 | 000LOC2 | 2,000 | 500 | 10,000 | 2,500 |
| 00004 | 000LOC2 | 2,000 | 500 | 10,000 | 2,500 |
| 00005 | 000LOC2 | 2,000 | 500 | 10,000 | 2,500 |
| 00006 | 000LOC2 | 2,000 | 500 | 10,000 | 2,500 |
| 00007 | 000LOC3 | 500 | 500 | 10,000 | 2,500 |
| 00008 | 000LOC3 | 500 | 500 | 10,000 | 2,500 |
| 00001 | 000LOC3 | 500 | 500 | 10,000 | 2,500 |
| 00002 | 000LOC3 | 500 | 500 | 10,000 | 2,500 |
| 00003 | 000LOC3 | 500 | 500 | 10,000 | 2,500 |
| 00004 | 000LOC3 | 500 | 500 | 10,000 | 2,500 |
| 00001 | 000LOC1 | 1,000 | 500 | 10,000 | 2,500 |
| 00002 | 000LOC1 | 1,000 | 500 | 10,000 | 2,500 |
| 00003 | 000LOC1 | 1,000 | 500 | 10,000 | 2,500 |
| 00004 | 000LOC1 | 1,000 | 500 | 10,000 | 2,500 |
| 00005 | 000LOC1 | 1,000 | 500 | 10,000 | 2,500 |
| 00006 | 000LOC1 | 1,000 | 500 | 10,000 | 2,500 |
| 00007 | 000LOC1 | 1,000 | 500 | 10,000 | 2,500 |
| 00008 | 000LOC1 | 2,000 | 500 | 10,000 | 2,500 |
| 00001 | 000LOC2 | 2,000 | 500 | 10,000 | 2,500 |
| 00002 | 000LOC2 | 2,000 | 500 | 10,000 | 2,500 |
| 00003 | 000LOC2 | 2,000 | 500 | 10,000 | 2,500 |
| 00004 | 000LOC2 | 2,000 | 500 | 10,000 | 2,500 |
| 00005 | 000LOC2 | 2,000 | 500 | 10,000 | 2,500 |
| 00006 | 000LOC2 | 2,000 | 500 | 10,000 | 2,500 |
| 00007 | 000LOC3 | 500 | 500 | 10,000 | 2,500 |
| 00008 | 000LOC3 | 500 | 500 | 10,000 | 2,500 |
| 00001 | 000LOC3 | 500 | 500 | 10,000 | 2,500 |

Table 3 includes material data and lot size data. The material data includes item and stocking facility. The lot size data includes fixed lot size (QFIX), minimum lot size increment (QUNIT), maximum lot size (QMAX), and minimum lot size (QMIN).

TABLE 4
Lead time data by item-stocking facility

| | | | Manufac- | | | | | | | | |
|---|---|---|---|---|---|---|---|---|---|---|---|
| | | | turing | | | | | | | | |
| | | | or | | | | | | | | |
| | | | supply | | | | | | Order | | |
| | | Cus- | planning | Manufac- | Manufac- | Trans- | Transpor- | | process- | | Remain- |
| | | tomer | and | turing | turing | por- | tation | | ing | | ing |
| | | order | scheduling | or | or | tation | Time | Order | time | Remaining | product |
| | | lead | lead | supply | supply | Time | Standard | processing | standard | product | life |
| | | time | time (in | lead | frequency | Mean | Deviation | time | deviation | life | standard |
| | Stocking | commit | days) | time | (days) | (days) | (days) | (days) | (days) | (weeks) | deviation |
| Item | Facility | (CLTC) | (PLT) | (PMLT) | (MLT) | (TLT) | (STLT) | (OPT) | (SOPT) | (PDURATION) | (SPDURATION) |
| 00001 | 000LOC1 | 2 | 7 | 10 | 5 | 5.00 | 2.0 | 1 | 1 | 52 | 10 |
| 00002 | 000LOC1 | 2 | 7 | 10 | 5 | 5.00 | 2.0 | 3 | 1 | 52 | 10 |
| 00003 | 000LOC1 | 2 | 7 | 20 | 5 | 7.00 | 3.0 | 3 | 2 | 52 | 10 |
| 00004 | 000LOC1 | 2 | 7 | 15 | 5 | 7.00 | 3.0 | 3 | 1 | 52 | 10 |
| 00005 | 000LOC1 | 2 | 7 | 10 | 7 | 7.00 | 3.0 | 1 | 1 | 52 | 10 |
| 00006 | 000LOC1 | 2 | 3 | 20 | 7 | 7.00 | 3.0 | 1 | 1 | 52 | 10 |
| 00007 | 000LOC1 | 2 | 3 | 15 | 7 | 7.00 | 3.0 | 2 | 1 | 12 | 10 |
| 00008 | 000LOC1 | 2 | 3 | 10 | 7 | 5.00 | 2.0 | 2 | 1 | 12 | 10 |
| 00001 | 000LOC2 | 2 | 3 | 20 | 5 | 7.00 | 3.0 | 2 | 1 | 12 | 10 |
| 00002 | 000LOC2 | 2 | 3 | 15 | 5 | 7.00 | 3.0 | 1 | 1 | 52 | 10 |
| 00003 | 000LOC2 | 2 | 3 | 10 | 5 | 5.00 | 2.0 | 1 | 1 | 52 | 10 |
| 00004 | 000LOC2 | 2 | 3 | 20 | 5 | 7.00 | 3.0 | 1 | 1 | 52 | 10 |
| 00005 | 000LOC2 | 2 | 5 | 15 | 7 | 7.00 | 3.0 | 1 | 1 | 52 | 10 |
| 00006 | 000LOC2 | 2 | 5 | 10 | 7 | 5.00 | 2.0 | 4 | 1 | 52 | 10 |
| 00007 | 000LOC3 | 2 | 5 | 20 | 7 | 7.00 | 3.0 | 4 | 2 | 52 | 10 |
| 00008 | 000LOC3 | 2 | 5 | 15 | 7 | 5.00 | 2.0 | 4 | 2 | 36 | 5 |
| 00001 | 000LOC3 | 2 | 5 | 10 | 7 | 7.00 | 3.0 | 1 | 1 | 36 | 5 |
| 00002 | 000LOC3 | 2 | 5 | 10 | 7 | 5.00 | 2.0 | 1 | 1 | 36 | 5 |
| 00003 | 000LOC3 | 2 | 5 | 20 | 7 | 5.00 | 2.0 | 1 | 1 | 36 | 5 |
| 00004 | 000LOC3 | 2 | 5 | 15 | 7 | 7.00 | 3.0 | 1 | 1 | 36 | 5 |

Table 4 includes material data and lead time data. The material data includes item and stocking facility. The lead time data includes customer order lead time commit (CLTC), manufacturing or supply planning and scheduling lead time (PLT), manufacturing or supply lead time (PMLT), manufacturing or supply frequency (MLT), transportation time mean (TLT), transportation time standard deviation (STLT), order processing time (OPT), order processing time standard deviation (SOPT), remaining product life (PDURATION), and remaining product life standard deviation (SPDURATION).

The enterprise resource planning system 102 may also include financial data 116. Financial data 116 may include cost and price related data such as cost of an item, price margin, inventory holding cost of an item, backlogging cost, shortage costs, salvage value of an item at the end of the life cycle, fixed cost of placing a replenishment order, and the like.

Table 5 illustrates exemplary financial data 116 that includes material data and cost data. The material data may include the item and the stocking facility. The cost data may include, for example, cost per unit (COST), fixed replenishment order cost (OCOST), holding cost rate (HCOST), price per unit (PRICE) price decline during remaining product life (PDECLINE), salvage value (SVALUE), and the like.

TABLE 5
Cost data by item-stocking facility

| | | | | | | | Price | |
|---|---|---|---|---|---|---|---|---|
| | | | | | | | Decline | |
| | | | | | | | during | |
| | | | Fixed | Holding | Shortage | | PDURATION | |
| | | | replenishment | cost | cost | | (% | Salvage |
| | | Cost per | order | rate (% | rate (% | | of | value (% |
| | Stocking | unit | cost | of cost) | of cost) | Price per unit | PRICE) | of cost) |
| Item | Facility | (COST) | (OCOST) | (HCOST) | (SCOST) | (PRICE) | (PDECLINE) | (SVALUE) |
| 00001 | 000LOC1 | $9,180 | $100 | 15.00% | 60% | $18,140 | 10% | $9,013 |
| 00002 | 000LOC1 | $3,920 | $50 | 20.00% | 50% | $6,059 | 10% | $3,797 |
| 00003 | 000LOC1 | $2,880 | $25 | 25.00% | 50% | $5,458 | 10% | $1,464 |
| 00004 | 000LOC1 | $2,861 | $200 | 10.00% | 40% | $4,058 | 10% | $1,628 |
| 00005 | 000LOC1 | $4,665 | $50 | 20.00% | 30% | $6,873 | 10% | $2,459 |
| 00006 | 000LOC1 | $2,363 | $25 | 25.00% | 20% | $2,881 | 10% | $2,330 |
| 00007 | 000LOC1 | $102 | $200 | 15.00% | 15% | $188 | 10% | $49 |
| 00008 | 000LOC1 | $2,871 | $100 | 20.00% | 15% | $2,945 | 10% | $2,206 |
| 00001 | 000LOC2 | $539 | $50 | 25.00% | 15% | $817 | 10% | $194 |
| 00002 | 000LOC2 | $9,961 | $25 | 10.00% | 15% | $10,301 | 10% | $6,833 |
| 00003 | 000LOC2 | $2,728 | $200 | 15.00% | 15% | $4,311 | 10% | $806 |
| 00004 | 000LOC2 | $162 | $100 | 20.00% | 15% | $262 | 10% | $19 |
| 00005 | 000LOC2 | $2,801 | $50 | 25.00% | 10% | $5,097 | 10% | $2,353 |
| 00006 | 000LOC2 | $3,595 | $25 | 10.00% | 10% | $6,111 | 10% | $491 |
| 00007 | 000LOC3 | $4,362 | $200 | 15.00% | 10% | $5,752 | 10% | $2,232 |
| 00008 | 000LOC3 | $4,036 | $100 | 20.00% | 10% | $5,884 | 10% | $3,611 |
| 00001 | 000LOC3 | $8,066 | $50 | 15.00% | 10% | $12,471 | 10% | $5,771 |
| 00002 | 000LOC3 | $5,983 | $25 | 20.00% | 10% | $8,664 | 10% | $3,236 |
| 00003 | 000LOC3 | $953 | $200 | 25.00% | 10% | $1,696 | 10% | $532 |
| 00004 | 000LOC3 | $6,790 | $100 | 10.00% | 10% | $8,632 | 10% | $1,468 |

The enterprise resource planning system 102 may also include demand forecast data 118. Demand forecast data 118 may include the demand forecast at a certain point in time for an item at an inventory location. Table 6 illustrates demand forecast data 118 that includes weekly, monthly, daily forecasts and the like, forecast errors, total demand forecast for the remaining life time, and the like.

TABLE 6
Demand forecast data by item-stocking facility

| | | | Demand | | Forecast | | | | | |
|---|---|---|---|---|---|---|---|---|---|---|
| | | Demand | forecast | | period | | | | | |
| | | forecast | error | | (1. | | | | | |
| | | until | until | Forecast | week, | | | | | |
| | | the | the | error | 2. | | | | | |
| | | end of | end of | (1 | month, | Demand | Demand | Demand | Demand | Demand |
| | Stocking | product | product | period | 3. | forecast - | forecast - | forecast - | forecast - | forecast - |
| Item | Facility | life | life | ahead) | quarter) | period 1 | period 2 | period 3 | period 4 | period 5 |
| 00001 | 000LOC1 | 387,590 | 41% | 207% | 950 | 971 | 1,027 | 1,047 | 1,241 | 1,336 |
| 00002 | 000LOC1 | 204,955 | 37% | 186% | 6,436 | 7,148 | 7,302 | 7,985 | 8,071 | 9,501 |
| 00003 | 000LOC1 | 315,221 | 22% | 108% | 225 | 252 | 270 | 302 | 306 | 308 |
| 00004 | 000LOC1 | 448,722 | 20% | 101% | 7,579 | 8,994 | 10,481 | 11,864 | 13,064 | 14,086 |
| 00005 | 000LOC1 | 490,643 | 1% | 5% | 3,467 | 3,566 | 3,625 | 4,316 | 4,939 | 5,104 |
| 00006 | 000LOC1 | 447,892 | 29% | 147% | 6,768 | 7,171 | 8,071 | 9,394 | 10,002 | 10,560 |
| 00007 | 000LOC1 | 207,050 | 47% | 235% | 9,660 | 11,306 | 12,425 | 12,502 | 13,062 | 14,584 |
| 00008 | 000LOC1 | 300,836 | 29% | 144% | 2,842 | 3,280 | 3,481 | 4,075 | 4,349 | 4,686 |
| 00001 | 000LOC2 | 430,363 | 44% | 221% | 6,976 | 8,348 | 8,537 | 9,894 | 10,746 | 11,617 |
| 00002 | 000LOC2 | 257,881 | 7% | 35% | 2,720 | 2,908 | 2,968 | 2,982 | 3,223 | 3,234 |
| 00003 | 000LOC2 | 416,596 | 40% | 198% | 3,409 | 3,855 | 3,996 | 4,582 | 5,325 | 5,624 |
| 00004 | 000LOC2 | 329,977 | 34% | 168% | 220 | 254 | 291 | 340 | 368 | 372 |
| 00005 | 000LOC2 | 347,486 | 7% | 34% | 1,814 | 1,879 | 2,116 | 2,269 | 2,521 | 2,545 |
| 00006 | 000LOC2 | 118,707 | 4% | 19% | 1,369 | 1,560 | 1,602 | 1,617 | 1,722 | 1,974 |
| 00007 | 000LOC3 | 354,905 | 1% | 7% | 5,308 | 5,512 | 5,633 | 6,264 | 7,406 | 8,491 |
| 00008 | 000LOC3 | 421,428 | 16% | 78% | 8,108 | 8,585 | 9,081 | 9,248 | 10,132 | 11,420 |
| 00001 | 000LOC3 | 482,809 | 39% | 195% | 2,862 | 3,284 | 3,521 | 4,158 | 4,261 | 4,288 |
| 00002 | 000LOC3 | 340,723 | 50% | 249% | 966 | 1,143 | 1,213 | 1,273 | 1,495 | 1,594 |
| 00003 | 000LOC3 | 176,363 | 48% | 238% | 7,687 | 8,650 | 9,369 | 10,832 | 12,191 | 13,810 |
| 00004 | 000LOC3 | 250,419 | 3% | 14% | 9,558 | 10,265 | 11,422 | 13,031 | 13,853 | 15,620 |

As explained above, each enterprise resource planning system 102 will have a corresponding data extractor 104. For example, in a SAP enterprise resource planning system, there are several data extractors that may be used to extract, transform, and load data into info-cubes of an application known as NetWeaver Business Integrator by SAP.

The inventory optimization system 100 also includes a structured query language database 106. Any type of structured query language database may be used, such as, for example, a DB2 database, a MySQL database, a Microsoft® SQL server, and the like, to store the data that comes from an extraction, transformation, and loading (ETL) process performed by the data extractor 104. The output of the extraction, transformation, and loading performed by the data extractor may include, for example, daily demand data by item-location, cost data by item location, customer lead time by item-location, lead time data by item-location, and the like.

The web based graphical user interface 108 may receive input from the user 110, such as, for example, inventory policy types 120, service targets 122, and “what if” questions 124. Typical what if questions may include, for example:

What happens to the performance metrics if replenishment lead time changes (e.g., increases or decreases by x %)?

What happens to the performance metrics if any other lead time changes (e.g. customer order lead time, customer order delivery commit window, transportation time, manufacturing frequency, actual manufacturing lead time, manufacturing planning and scheduling lead time, order processing time) (e.g., increases or decreases by x %)?

What happens to the performance metrics if average demand changes by x %?

What happens to the performance metrics if service type changes (e.g., from fill rate to on time delivery to commit) by x %?

What happens to the performance metrics if target service level changes (e.g., increases or decreases by x %)?

What happens to the performance metrics if inventory policy changes (e.g., profit maximization to cost minimization or target fill rate achievement)?

What happens to the performance metrics if lead time changes (e.g., increases or decreases by x %)?

The Web based graphical user interface 108 also includes a structured query language query engine 126. The structured query language query engine 126 is the query engine that runs structured query language commands to calculate the inventory policies and performance metrics for a selected group of item-location pairs.

Item-location pairs may be selected according to their attributes. For example, items may be grouped by a classification, such as, geography, product family, brand, price, customer class, or the like. Then any sub-group of items may be selected using the selection criteria. Inventory policy calculations and performance metrics calculations may be done for the selected sub-group of items.

The Web based graphical user interface 108 may provide outputs, such as, for example, inventory policies 128, performance metric projections 130, and “what-if” analysis results 132.

An exemplary embodiment of the present invention may determine a time window for which data will be collected. In order to pick the most relevant data for inventory policy calculations, a time window may be determined as a prerequisite. The time window may be selected based upon seasonal variations, and/or the correct period of historical data which may best represent an immediate future order stream. This embodiment of the present invention provides a flexible method for determining the period over which data may be collected for performing subsequent inventory allocation determinations.

This flexible method may rely upon two parameters as input: a start date and an end date. These dates may then determine the period in the historical data that will be collected. This period may be called a “data time window.” The start date may be determined based upon the following equation:

STARTDATE=TODAY−WINDOWOFFSET+DELAY (1)

where:

TODAY is today's date;

WINDOWOFFSET is an input that indicates the number of days from today's date to go back before data may be collected; and

DELAY is the amount of time it takes to put the current safety stock in effect due to replenishment lead time delays and other factors. If this input is unknown, then it may be set at total replenishment lead time (RLT) as a default.

The end date may be determined based upon the following equation:

ENDDATE=STARTDATE+WINDOWLENGTH−1 (2)

where:

WINDOWLENGTH is the number of days that specifies the length of time within the window for which the data should be collected. This may be input by a user.

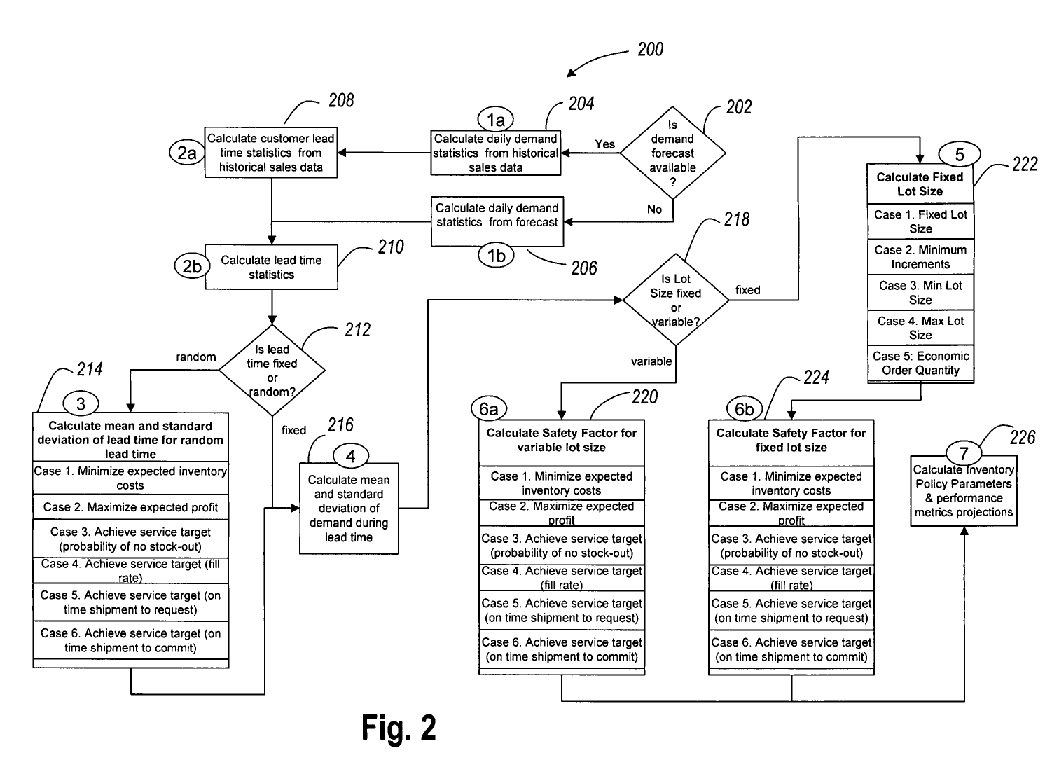

FIG. 2 illustrates a flowchart 200 for an exemplary inventory optimization in structured query language according to the present invention. Flowchart 200 starts at step 202 where the structured query language system determines whether a demand forecast is available. If, at step 202, the structured query language system determines that a demand forecast is available, then the system continues to step 204.

In step 204, the structured query language system calculates the daily demand statistics from historical sales data. The daily demand statistics that are calculated in step 204 may include the sum of all (total) order quantities (TOQ), the average order quantity (AOQ), the sum of the squares of all (total) order quantities (TOQS), the standard deviation of order quantity per order (SOQ), the average number of orders per day (OAR), the average demand during a day (AOD), the standard deviation of demand during a day (SOD), and the like.

The sum of all order quantities may be determined based upon the following equation:

TOQ=ORQ[1]+ORQ[2]+ . . . +ORQ[N] (3)

where:

ORQ[i] is the order quantity for each item.

The average order quantity per order in the data time window may be determined based upon the following equation:

AOQ=TOQ/N (4)

where:

N is the number of orders during T number of days; and

T is the number of days in the data time window.

The sum of squares of all orders in the data time window may be determined based upon the following equation:

TOQS=ORQ[1]²+ORQ[2]²+ . . . +ORQ[N]² (5)

The standard deviation of order quantity per order may be determined based upon the following equation:

SOQ=((TOQS−N×AOQ²)/(N−1))^{1/2} (6)

The average number of orders per day may be determined based upon the following equation:

OAR=N/T (7)

The average demand during a day may be determined based upon the following equation:

AOD=OAR×AOQ (8)

The standard deviation of demand during a day may be determined based upon the following equation:

SOD=(AOD²+OAR×SOQ²)^{1/2} (9)

After performing the above-identified calculations, the flowchart continues to step 208, where the system calculates customer lead time statistics from historical sales data. These customer lead time statistics may include, for example, the customer lead times (CLT) based on requested ship dates and order entry dates, the sum of customer lead times of all orders in the data time window (TCLT), the average customer lead time per order (CLTR), the sum of customer lead time squares of all orders in the data time window (TCLTS), the standard deviation of customer lead time per order (SCLTR, and the like.

The customer lead times may be determined based upon the following equation:

CLT[i]=RSD[i]−OED[i] (10)

for all i=1, 2, . . . , N

where:

RSD[i] is the requested ship date for order i; and

OED[i] is the order entry date for order i.

The sum of customer lead times may be determined based upon the following equation:

TCLT=CLT[1]+CLT[2]+ . . . +CLT[N] (11)

The average customer lead time per order may be determined based upon the following equation:

TCLTS=CLT[1]²+CLT[2]²+ . . . +CLT[2]² (12)

The average customer lead time time per order may be determined based upon the following equation:

ACLT=TCLT/N (13)

The standard deviation of customer lead time per order may be determined based upon the following equation:

SCLTR=((TCLTS=N×ACLT²)/(N−1))^{1/2} (14)

Alternatively, if, in step 202, the structured query language system 126 determines that the demand forecast is not available, then the system continues to step 206. In step 206, the structured query language system 126 calculates daily demand statistics from a weekly demand forecast. The daily demand statistics may include the mean daily demand in week m (DD[i]), the standard deviation of daily demand in week m (SDD[i]), the average demand during a day (AOD), the standard deviation of demand during a day (SOD), and the like.

The mean daily demand in week m may be determined based upon the following equations 15 and 16:

m=ROUNDUP(I/M) (15)

where:

M is the number of working days in a period; and

ROUNDUP is a function that gives the smallest integer greater than or equal to I/M.

DD[i]=WD[m]M (16)

where:

WD[m] is the demand forecast in a period (m=1, 2, . . . )

The standard deviation of daily demand in week m may be determined based upon the following equation:

SDD[i]=FE×(m×M)^{1/2} (17)

where:

FE is the forecast error for the period ahead.

The average demand during a day may be determined based upon the following equation:

AOD=(DD[1]+DD[2]+ . . . +DD[RLT])/RLT (18)

where:

RLT is the replenishment lead time.

The standard deviation of demand during a day may be determined based upon the following equation:

SOD=((SDD[1]²+SDD[2]²+ . . . +SDD[RLT]²)/RLT)^{1/2} (19)

The structured query language system may then proceed to step 210. In step 210, the structured query language system may calculate lead time statistics. An exemplary embodiment of the present invention may assume that all lead times are random except the manufacturing planning lead time (PLT) and the customer order lead time commit (CLTC).

The waiting time of the order until the next cycle may be set to 0.5×MLT and the transportation time to TLT. The waiting time may be assumed to have a uniform distribution. When a replenishment order comes to manufacturing, it may come any time within a complete manufacturing cycle of MLT. Therefore, the amount of time it will have to wait to get scheduled depends on when it arrives during the cycle. If it has just missed a cycle, it will have to wait MLT days (a complete manufacturing cycle length). If it has come just before a new cycle is about to begin, it will not wait. Therefore, an order may be exemplarily assumed to wait an average of 0.5×MLT.

The standard deviation may be determined based upon the following equation:

STDEV(0.5×MLT)=0.5×MLT/12^{1/2} (20)

The variance may be determined based upon the following equation:

VARIANCE(0.5×MLT)=MLT²/48 (21)

The mean transportation lead time may be determined based upon the following equation:

TLT=(TLT[1]+TLT[2]+ . . . +TLT[k])/K (22)

where:

K is the number of lead time observations in a sample.

The sum of the squares of transportation lead times may be determined based upon the following equation:

TLTS=TLT[1]²+TLT[2]²+ . . . +TLT[K]² (23)

The standard deviation of the transportation lead time may then be determined based upon the following equation:

STLT=((TLTS−K×TLT²)/(K−1))/^{1/2} (24)

The structured query language system may then continue to step 212, where the system determines whether the lead time is fixed or random.

If, in step 212, the system determines that the lead time is random, then it continues to step 214.

In step 214, the system calculates the mean and standard deviation of lead time for random lead time. The method by which these are determined may be varied in accordance with the objectives. The objectives may be different. Exemplary cases may include: Case 1—minimize expected inventory costs; Case 2—maximize expected profit; Case 3—achieve service target based upon a probability of no stock-out; Case 4—Achieve a service target for a fill rate; Case 5—Achieve a service target for on time shipment to requests; and Case 6—Achieve a service target to achieve on time shipment to commits.

For Case 1, if inventory is reviewed and replenished continuously (e.g., manufacturing may be done any time, or purchase may be done at any time) then the net delay in lead time, NDLT, may be determined based upon the following equation:

NDLT=PLT (25)

If, however, the inventory is reviewed and supply replenishment is done periodically with a period length MLT, then, NDLT may be determined based upon the following equation:

NDLT=max(0.5×MLT,PLT); and (26)

where:

MLT is the manufacturing or supply frequency. This represents how often a manufacturing cycle is run or supply orders are placed. For instance, if MLT=7, then manufacturing is run every week or supply orders are given to the supplier every week.

The standard deviation of NDLT, (SNDLT) may be determined based upon the following equation:

SNDLT=(SPMLT²+MLT²/48)^{1/2} (27)

where:

SPMLT is the standard deviation of PMLT with the manufacturing or supply lead time. For example, if PMLT=3, then it takes three days to complete a manufacturing run (from start to finish) or it takes three days to get the supply from the supplier (from order placement to order arrival).

Then, the random replenishment lead time may be determined based upon the following equation:

RLT=OPT+TLT+PMLT+NDLT (28)

where:

OPT is the order processing time;

TLT is the transportation lead time; and

PMLT is the manufacturing (or supply) lead time.

The system may then determine the standard deviation for the random lead time based upon the following equation:

SRLT=(SOPT²+STLT²+SNDLT²)^{1/2} (29)

where:

SOPT is the standard deviation of the order processing time; and

STLT is the standard deviation of the transportation lead time.

For case 2, which maximizes expected profit, the random lead time may be determined based upon the following equation:

RLT=PDURATION (30)

where:

PDURATION is the input duration of a season during which expected profit is to be maximized.

The system may then determine the standard deviation for the random lead time based upon the following equation:

SRLT=SPDURATION (31)

where:

SPDURATION is the input standard deviation of the duration of a season during which expected profit is to be maximized that is provided by the user.

For case 3, in which it is desired to achieve a predetermined probability of no stock-out, the random lead time may be determined based upon the following equation:

RLT=OPT+TLT+PMLT+NDLT (32)

where:

OPT is the order processing time;

TLT is the transportation lead time;

PMLT is manufacturing lead time; and

The system may then determine the standard deviation for the random lead time based upon the following equation:

SRLT=(SOPT²+STLT²+SNDLT²)^{1/2} (33)

where:

SOPT is the input standard deviation of the order processing time; and

STLT is the input standard deviation of the transportation lead time.

For case 4, in which a fill rate service target is desired to be achieved, the random lead time may be determined based upon the following equation:

RLT=OPT+TLT+PMLT+NDLT (34)

where:

OPT is the order processing time;

TLT is the transportation lead time;

PMLT is manufacturing lead time; and

NDLT is net delay in lead time.

The system may then determine the standard deviation for the random lead time based upon the following equation:

SRLT=(SOPT²+STLT²+SNDLT²)^{1/2} (35)

where:

SOPT is the input standard deviation of the order processing time; and

STLT is the input standard deviation of the transportation lead time.

For case 5, in which a predetermined time shipment to request may be achieved, the random lead time may be determined based upon the following equation:

RLT=OPT+TLT+PMLT+NDLT−CLTR (36)

where:

OPT is the order processing time;

TLT is the transportation lead time;

PMLT is manufacturing lead time; and

CLTR is the customer order lead time requested by the customer.

The system may then determine the standard deviation for the random lead time based upon the following equation:

SRLT=(SOPT²+STLT²+SNDLT²+SCLTR²)^{1/2} (37)

where:

SOPT is the input standard deviation of the order processing time;

STLT is the input standard deviation of the transportation lead time; and

SCLTR is the input standard deviation of the customer order lead time as requested by the customer.

For case 6, in which a predetermined on time shipment to commit may be achieved, the random lead time may be determined based upon the following equation:

RLT=OPT+TLT+PMLT+NDLT−CLTC (38)

where:

OPT is the order processing time;

TLT is the transportation lead time;

PMLT is manufacturing lead time; and

CLTC is the customer order lead time commit.

The system may then determine the standard deviation for the random lead time based upon the following equation:

SRLT=(SOPT²+STLT²+SNDLT²)^{1/2} (39)

where:

SOPT is the input standard deviation of the order processing time; and

STLT is the input standard deviation of the transportation lead time.

If inventory is reviewed and replenished continuously, then NDLT=PLT and SNDLT=SPMLT.

If inventory is reviewed and supply replenishment is done periodically with a period length of MLT, then

NDLT=max(0.5×MLT, PLT); and (40)

SNDLT=(SPMLT²+MLT²/48)^{1/2}. (41)

The system then continues to step 216. In step 216, the system calculates the mean and standard deviation of demand during a lead time. The average demand during the replenishment lead time may be based upon the following equation:

ADLT=AOD×RLT (42)

where:

ADLT is the average demand during replenishment lead time;

AOD is average demand during a day; and

RLT is the replenishment lead time.

The system also determines the standard deviation of demand during lead time based upon the following equation:

SDLT=SOD×(RLT)^{1/2} (43)

where:

SOD is the input standard deviation of the amount of quantity ordered during a day; and

RLT is the replenishment lead time.

If, in step 212, the system determines that the lead time is fixed, then it continues to step 216. Next, the system continues to step 218. In step 218, the system determines whether the lot size is fixed or variable.

If, in step 218, the system determines that the lot size is fixed, then the system continues to step 222. In step 222 the system calculates the fixed lot size based upon an appropriate case. For example, case 1 may be for where a predetermined lot size QFIX is available, in which whenever inventory position comes down to a re-order point ROP, the quantity QFIX is ordered, case 2 may be for minimum increments, case 3 may be for minimum lot size, case 4 may be for maximum lot size, and case 5 may be for an economic order quantity.

For case 1, the fixed lot size LOT is set to the value of QFIX which is a predetermined lot size.

If, however, there is no predetermined lot size QFIX, then the system calculates the fixed lot size based upon the following equation:

LOT=AOD×RLT (44)

where:

AOD is the average demand during a day; and

RLT is replenishment lead time.

For case 2, the lot size must be an integer multiple of a minimum number (QUNIT), the lot size is then determined based upon the following equation:

LOT=M×QUNIT (45)

where:

M is the number of working days in a period; and

QUNIT is the unit lot size.

For case 3, the lot size may be any number, but must be above a minimum. In this case, the lot size is determined based upon the following equation:

LOT=max (QMIN, ROP−IP) (46)

where:

QMIN is the minimum lot size;

ROP is the re-order point; and

IP is the inventory position for a re-order point.

For case 4, the lot size may be any size as long as it is below a maximum. In this case, the lot size is determined based upon the following equation:

LOT=min (QMAX, ROP−IP) (47)

where:

QMAX is the maximum lot size;

ROP is the re-order point; and

IP is the inventory position for a re-order point.

For case 5, when costs are provided, an economic order quantity (EOQ) may be calculated. The economic order quantity may be determined based upon the following equation:

EOQ=sqrt (2×AOD×OCOST/HCOST) (48)

where:

AOD is the average demand during a day;

OCOST is the fixed cost per order; and

HCOST is the inventory holding cost.

After the economic order quantity EOQ has been determined, the lot size LOT may be set to equal EOQ.

Next, the system continues to step 224, where the system calculates a safety factor for a fixed lot size based upon an appropriate case. For example, case 1 may minimize the expected inventory costs, case 2 may maximize the expected profit, case 3 may achieve a targeted probability of no stock-out, case 4 may achieve a targeted fill rate, case 5 may achieve a targeted on time shipment to request, and case 6 may achieve a targeted on time shipment to commit. Each of these cases may be indicated by a corresponding value in a POLICY field.

For case 1, the objective is to minimize the expected inventory holding and backlogging costs. The assumption is that demand not met immediately is backlogged and backlogging has a cost. That cost may include, for example, the cost of expediting orders, paying a penalty to the customer, buying inventory at a high cost, loss of goodwill and the like. This exemplary embodiment minimizes the expected inventory carrying and backlogging costs during the current replenishment lead time and ignores the periods that are beyond that lead time.

The system first determines an intermediate value PVALUE based upon the following equation:

PVALUE=SCOST/(SCOST+HCOST) (49)

where:

SCOST is an input shortage cost; and

HCOST is an input inventory holding cost.

The system next determines another intermediate value ZVALUE based upon the following equation:

ZVALUE=(LOT×(1−PVALUE)/(SDLT×PVALUE))^{1/2} (50)

where:

LOT is the input lot size; and

SDLT is the input standard deviation of demand during replenishment lead time.

The system may then determine the safety factor k based upon the following equation:

k=1.187918+0.108/ZVALUE−2×ZVALUE (51)

The constants in the above and following equations are determined using a total absolute error minimization method to fit the approximation to the actual function being approximate with minimal total error.

For case 2, the objective is to maximize the expect profit (revenue—purchase cost—inventory cost). This is typically used in cases where there is a large quantity purchase (or manufacturing build) prior to a season. The objective is to supply (purchase or build) the correct quantity to maximize the expected profit in that season. Excess supply may be sold at the end of the season. Further, supply shortages cause revenue and profit shortfalls.

An intermediate value SVALUE, which is the value per unit for any unsold units left at the end of a season when salvaged, is calculated based on the following equation:

SVALUE=PRICE−PDECLINE (52)

where:

PRICE is the price of a unit; and

PDECLINE is the price decline of a unit during a season.

For perpetual items where there is no (or minimal) price decline, this model may not be appropriate. For such items, there is a perpetual demand and the focus is typically on cost minimization or service target achievement instead of profit maximization.

An intermediate value PVALUE that maximizes the expected profit during the season is then calculated based on the following equation:

PVALUE=(PRICE−COST)/(PRICE−SVALUE) (53)

where:

COST is the cost of a unit.

Another intermediate value ZVALUE is then calculated based on the following equation:

ZVALUE=(LOT×(1−PVALUE)/(SDLT×PVALUE))^{1/2} (54)

where:

LOT is the lot size; and

SDLT is the input standard deviation of demand during replenishment lead time.

The safety factor k may then be determined based upon the following equation:

k=1.187918+0.108 (ZVALUE−2×ZVALUE) (55).

For case 3, achieving a service target of a probability of no stock-out, an intermediate value of ZVALUE may be determined based upon the following equation:

ZVALUE=(LOT×(1−PNS)/(SDLT×PNS))^{1/2} (56)

where:

PNS is the desired probability of no stock-out;

LOT is the lot size; and

SDLT is the standard deviation of demand during replenishment lead time.

The safety factor k may then be determined based upon the following equation:

k=1.187918+0.108/ZVALUE−2×ZVALUE. (57)

For case 4, it is desired to achieve a target fill rate. First, an intermediate value ZVALUE is determined based upon the following equation:

ZVALUE=(LOT×(1−FRT)/(SDLT×FRT))^{1/2} (58)

where:

FRT is the desired fill rate; and

SDLT is the standard deviation of demand during replenishment lead time.

Next, the safety factor k is determined based upon the following equation:

k=(−0.152389+0.01811/ZVALUE−0.11532×ZVALUE)×ADLT/SDLT+1.307801+0.07540/ZVALUE−1.273389×ZVALUE. (59)

For case 5, it is desired to achieve a targeted on time shipment to request. An intermediate value is first determined based upon the following equation:

ZVALUE=(LOT×(1−OTDR)/(SDLT×OTDR))^{1/2} (60)

where:

OTDR is the on time delivery to customer request;

LOT is the lot size; and

SDLT is the standard deviation during replenishment lead time.

The safety factor k may then be determined based upon the following equation:

K=1.187918+0.108/ZVALUE−2×ZVALUE. (61)

For case 6, it is desired to achieve a targeted on time shipment to commit. An intermediate value is first determined based upon the following equation:

ZVALUE=(LOT×(1−OTDC)/(SDLT×OTDC))^{1/2} (62)

where:

OTDC is the on time delivery to commit;

LOT is the lot size; and

SDLT is the standard deviation during replenishment lead time.

The safety factor k may then be determined based upon the following equation:

K=1.187918+0.108/ZVALUE−2×ZVALUE. (63)

If, on the other hand, the system determines in step 218, that the lot size is variable, then the system proceeds to step 220. In step 220, the system calculates the safety factor for a variable lot size based upon an appropriate case. For example, case 1 may minimize the expected inventory costs, case 2 may maximize the expected profit, case 3 may achieve a service target (targeted probability of no stock-out), case 4 may achieve a service target (targeted fill rate), case 5 may achieve a service target (targeted on time shipment to request), and case 6 may achieve a service target (targeted on time shipment to commit). Each of these cases may be indicated by a corresponding value in a POLICY field.

For case 1, the objective is to minimize the expected inventory holding and backlogging costs. The assumption is that demand not met immediately is backlogged and backlogging has a cost as described above. That cost may include, for example, the cost of expediting orders, paying a penalty to the customer, buying inventory at a high cost, loss of goodwill and the like. This exemplary embodiment minimizes the expected inventory carrying and backlogging costs during the current replenishment lead time and ignores the periods that are beyond that lead time.

The system first determines an intermediate value PVALUE based upon the following equation:

PVALUE=SCOST/(SCOST+HCOST) (64)

where:

SCOST is an input shortage cost; and

HCOST is an input inventory holding cost.

If PVALUE is<0.5, set MULTIPLIER=−1, and if PVALUE is>=0.5, set MULTIPLIER to 1.

The safety factor may then be determined based upon the following equation:

$$\begin{matrix}k = MULTIPLIER \times ( 1.36347118152855 - \\ sqrt ( max ( 0 , {( 1.36347118152885 )}^{2} + \\ 4 \times 0.266705003408527 \times \\ ( - ln ( 1 / max ( PVALUE , 1 - PVALUE ) - 1 ) ) ) ) ) / ( - 2 \times \\ 0.266705003408527 ) .\end{matrix} \qquad ( 65 )$$

For case 2, the objective is to maximize the expect profit (revenue—purchase cost—inventory cost). This is typically used in cases where there is a large quantity purchase (or manufacturing build) prior to a season. The objective is to supply (purchase or build) the correct quantity to maximize the expected profit in that season. Excess supply may be sold at the end of the season. Further, supply shortages cause revenue and profit shortfalls.

An intermediate value SVALUE, which is the value per unit for any unsold units left at the end of a season when salvaged, is calculated based on the following equation:

SVALUE=PRICE−PDECLINE (66)

where:

PRICE is the price of a unit; and

PDECLINE is the price decline of a unit during a season.

For perpetual items where there is no or minimal price decline this model may not be appropriate. For such items, there is a perpetual demand and the focus is typically on cost minimization or service target achievement instead of profit maximization.

An intermediate value PVALUE that maximizes the expected profit during the season is then calculated based on the following equation:

PVALUE=(PRICE−COST)/(PRICE−SVALUE) (67)

where:

COST is the cost of a unit.

If PVALUE is<0.5, set MULTIPLIER=−1, and if PVALUE is>=0.5, set MULTIPLIER to 1.

The safety factor may then be determined based upon the following equation:

$$\begin{matrix}k = MULTIPLIER \times ( 1.36347118152855 - \\ sqrt ( max ( 0 , {( 1.36347118152885 )}^{2} + \\ 4 \times 0.266705003408527 \times \\ ( - ln ( 1 / max ( PVALUE , 1 - PVALUE ) - 1 ) ) ) ) ) / ( - 2 \times \\ 0.266705003408527 ) .\end{matrix} \qquad ( 68 )$$

For case 3, achieving a service target of a probability of no stock-out, If PNS is<0.5, set MULTIPLIER=−1, and if PNS is>=0.5, set MULTIPLIER to 1.

The safety factor may then be determined based upon the following equation:

$$\begin{matrix}k = MULTIPLIER \times ( 1.36347118152855 - \\ sqrt ( max ( 0 , {( 1.36347118152885 )}^{2} + \\ 4 \times 0.266705003408527 \times \\ ( - ln ( 1 / max ( PNS , 1 - PNS ) - 1 ) ) ) ) ) / ( - 2 \times \\ 0.266705003408527 ) .\end{matrix} \qquad ( 69 )$$

For case 4, it is desired to achieve a target fill rate. First, an intermediate value GVALUE may be determined based upon the following equation;

GVALUE=(1−FRT)×SDLT/(ADLT+1E−30) (70)

where:

FRT is the desired fill rate;

SDLT is the standard deviation of demand during replenishment lead time; and

ADLT is the average demand during replenishment lead time.

Next, the safety factor k is determined based upon the following equation:

k=((−1.155503248−sqrt(max(0,(1.155503248)²−4×0.38178158×(0.93767426−1n(1/((SDLT/(ADLT+1E−30))×GVALUE+1E−30))))))/(2×0.38178158)). (71)

For case 5, it is desired to achieve a targeted on time shipment to request, if OTDR is<0.5, set MULTIPLIER=−1, and if OTDR is>=0.5, set MULTIPLIER to 1.

The safety factor may then be determined based upon the following equation:

$$\begin{matrix}k = MULTIPLIER \times ( 1.36347118152855 - \\ sqrt ( max ( 0 , {( 1.36347118152885 )}^{2} + \\ 4 \times 0.266705003408527 \times \\ ( - ln ( 1 / max ( OTDR , 1 - OTDR ) - 1 ) ) ) ) ) / ( - 2 \times \\ 0.266705003408527 ) .\end{matrix} \qquad ( 72 )$$

For case 6, it is desired to achieve a targeted on time shipment to commit, if OTDC is<0.5, set MULTIPLIER=−1, and if OTDC is>=0.5, set MULTIPLIER to 1.

The safety factor may then be determined based upon the following equation:

$$\begin{matrix}k = MULTIPLIER \times ( 1.36347118152855 - \\ sqrt ( max ( 0 , {( 1.36347118152885 )}^{2} + \\ 4 \times 0.266705003408527 \times \\ ( - ln ( 1 / max ( OTDC , 1 - OTDC ) - 1 ) ) ) ) ) / ( - 2 \times \\ 0.266705003408527 ) .\end{matrix} \qquad ( 73 )$$

After step 220, or step 224, the system may then continue to step 226. In step 226, the system calculates the inventory policy parameters and performance metric projections.

The safety stock SS may be determined based upon the following equation:

SS=k×SDLT. (74)

The reorder point ROP may be determined based upon the following equation:

ROP=ADLT+SS (75)

The maximum inventory level may be determined based upon the following equation:

MAX=ROP+LOT (76)

The recommended supply may be determined based upon the following equation:

SUPPLY=max(0, ROP−IP) (77)

The average inventory level projection may be determined based upon the following equation:

AINV=ROP+LOT−ADLT (78)

The inventory level standard deviation may be determined based upon the following equation:

SINV=SDLT (79)

The minimum inventory level for a 95% interval may be determined based upon the following equation:

MININV=AINV−1.96×SINV (80)

The maximum inventory level for a 95% interval may be determined based upon the following equation:

MAXINV=AINV−1.96×SINV. (81)

The cost for each of these inventory policies and performance metrics may be determined by multiplying each amount by the cost per unit.

These inventory policies and performance metrics may also be provided based upon an amount for each turn by dividing each value into AOD×M×NPERIOD, respectively.

The system may also determine the following intermediate values:

ZVALUE=(ROP−ADLT)/SDLT (82)

CDF=1/(1+exp(−2*(0.7988*abs(ZVALUE)* (1+0.04417*ZVALUE²)))) (83 80)

PDF=exp (−0.5*ZVALUE²)/(2□)^{1/2} (84)

GVALUE=PDF−ZVALUE*(1−CDF) (85)

The probability of no stock-out may be determined based on the following equation:

PNSP=if (ZVALUE>0) then CDF else 1−CDF (86)

The probability of on time delivery to customer request may be determined based on the following equation:

OTDRP=if (ZVALUE>0) then CDF else 1−CDF (87)

The probability of on time delivery to commit projection may be determined based on the following equation:

OTDCP==if (ZVALUE >0) then CDF else 1−CDF (88)

A fill rate projection may be determined based on the following equation:

FRP=1−GVALUE*ADLT/SDLT (89)

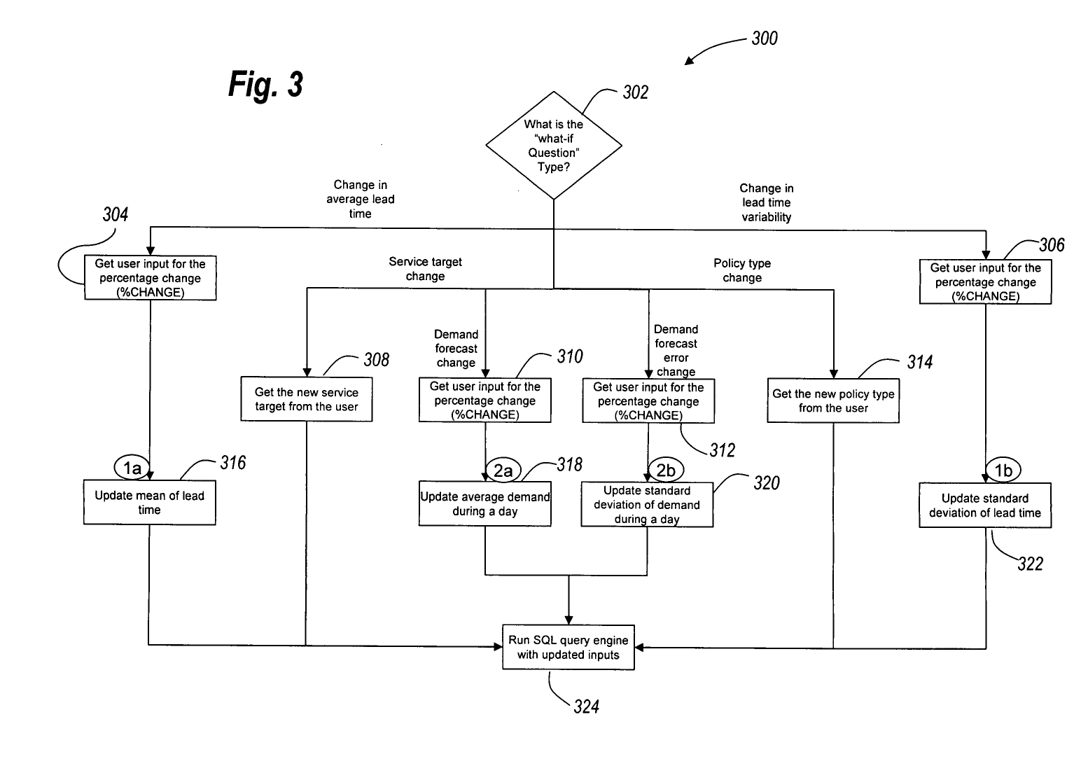

FIG. 3 illustrates a flowchart 300 in accordance with an exemplary embodiment of the present invention to handle “what if” questions from a user.

The flowchart starts at step 302, where the system determines the type of “what if” question. The system determines whether it is a “change in average lead time” question, a “service target change” question, a “demand forecast change” question, a “demand forecast error change” questions, a “policy type change” question, or a “change in lead time variability” question.

If, in step 302, the system determines that the “what if” question is a “change in average lead time” question, the system continues to step 304. In step 304, the system receives user input on the percentage change (% CHANGE) in the average lead time and continues to step 316.

In step 316, the system updates the mean lead time by performing the following operations:

OPT(new)=OPT(old)*(1+% CHANGE); (90)

PDURATION(new)=PDURATION(old)*(1+% CHANGE); (91)

TLT(new)=TLT(old)*(1+% CHANGE); (92)

PMLT(new)=PMLT(old)*(1+% CHANGE); (93)

CLTR(new)=CLTR(old)*(1+% CHANGE); (94)

CLTC(new)=CLTR(old)*(1+% CHANGE); and (95)

RLT(new)=RLT(old)*(1+% CHANGE). (96)

The system then continues to step 324, where the system executes the structured query language engine in accordance with the flow chart of FIG. 2.

If, however, the system determines that the “what if” question is a service target change, then the system continues to step 308.

In step 308, the system receives the new service target from the user and then continues to step 324.

If, however, the system determines that the “what if” question is a demand forecast change, then the system continues to step 310.

In step 310, the system receives user input for the percentage change (% CHANGE) and continues to step 318. In step 318, the system updates the average demand during a day based upon the following equation:

AOD(new)=AOD(old)*(1+% CHANGE) (97)

The system then continues to step 324.

If, however, in step 302, the system determines that the “what if” question is a demand forecast error change, then the system continues to step 312. In step 312, the system receives the user input for the percentage change (% CHANGE) in the demand forecast error and continues to step 320.

In step 320, the system updates the standard deviation of demand during a day based on the following equation:

SOD(new)=SOD(old)*(1+% CHANGE)*AOD(new)/AOD(old) (98)

Then the system continues to step 324.

If, however, in step 302, the system determines that the “what if” question is a policy type change, then the system continues to step 314.

In step 314, the system receives the new policy type from the user and continues to step 324.

If, however, in step 302, the system determines that the “what if” question is a change in lead time variability, then the system continues to step 306. In step 306, the system receives input from the user regarding the percentage change (% CHANGE) and continues to step 322.

In step 322, the system updates the standard deviation of lead time by performing the following calculations:

SOPT(new)=SOPT(old)*(1+% CHANGE)*OPT(new)/OPT(old); (99)

SPDURATION(new)=SPDURATION(old)*(1+% CHANGE)*PDURATION(new)/PDURATION(old); (100)

STLT(new)=STLT(old)*(1+% CHANGE)*TLT(new)/TLT(old); (101)

SPMLT(new)=SPMLT(old)*(1+% CHANGE)*PMLT(new)/PMLT(old); (102)

SCLTR(new)=SCLTR(old)*(1+% CHANGE)*CLTR(new)/CLTR(old); and (103)

SRLT(new)=SRLT(old)*(1+% CHANGE)*RLT(new)/RLT(old). (104)

The system then continues to step 324. In step 324, the structured query language engine is run with the updated inputs.

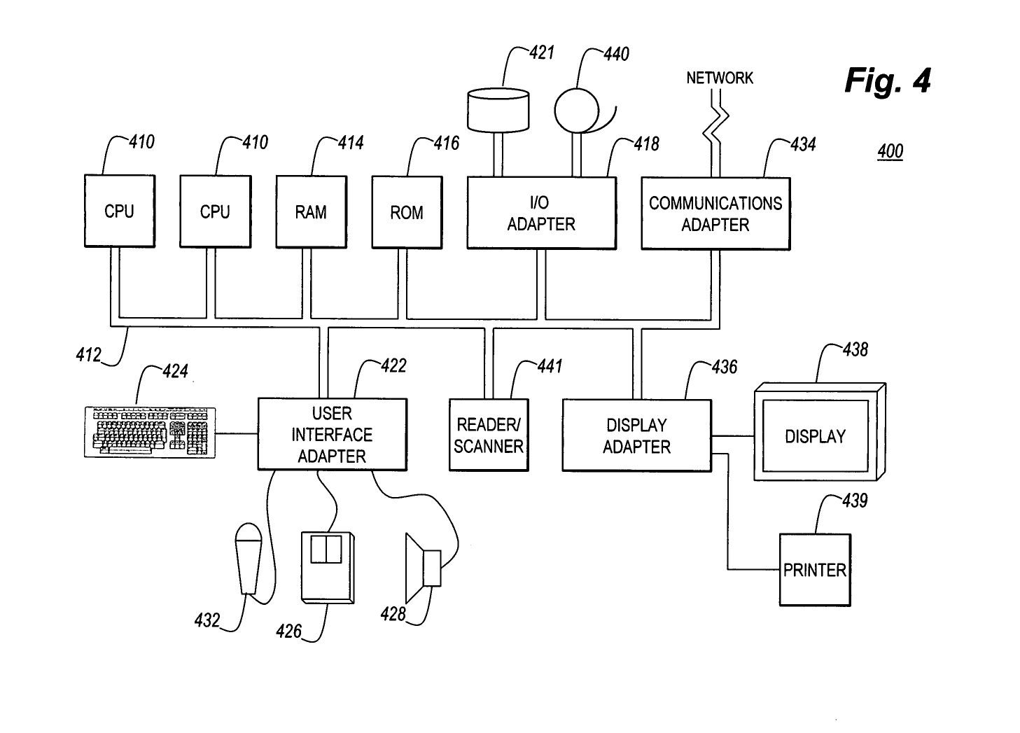

Referring now to FIG. 4, system 400 illustrates a typical hardware configuration which may be used for implementing the inventive system and method for buying and selling merchandise. The configuration has preferably at least one processor or central processing unit (CPU) 410. The CPUs 402 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting an information handling system to a data processing network, the Internet, and Intranet, a personal area network (PAN), etc., and a display adapter 436 for connecting the bus 412 to a display device 438 and/or printer 439. Further, an automated reader/scanner 441 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a program embodied in a computer readable medium executable by a digital processing unit to perform the above method.

Such a method may be implemented, for example, by operating the CPU 410 to execute a sequence of machine-readable instructions. These instructions may reside in various types of signal bearing media.

Thus, this aspect of the present invention is directed to a programmed product, comprising signal-bearing media tangibly embodying a program of machine-readable instructions executable by a digital data processor incorporating the CPU 410 and hardware above, to perform the method of the invention.

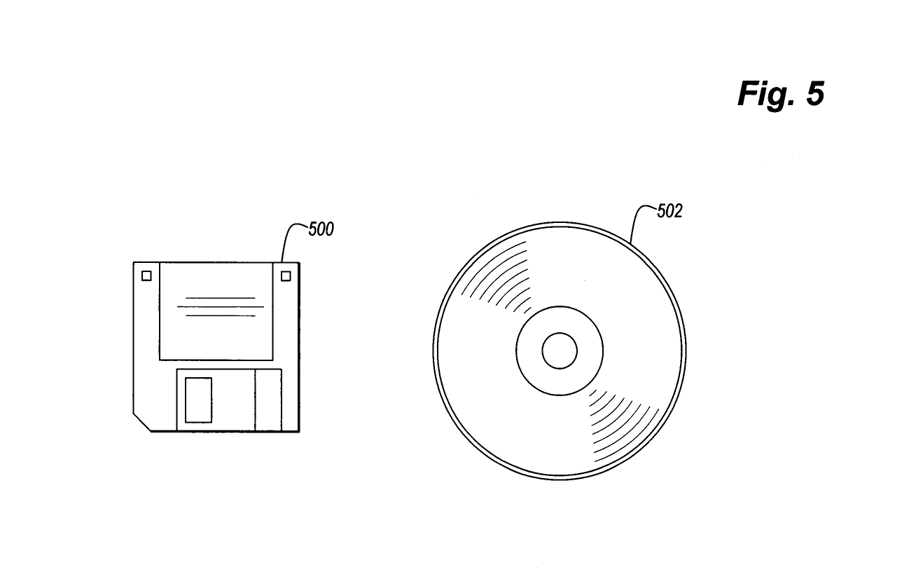

This signal-bearing media may include, for example, a RAM contained within the CPU 410, as represented by the fast-access storage for example. Alternatively, the instructions may be contained in another signal-bearing media, such as a magnetic data storage diskette 500 or CD-ROM 502, (FIG. 5), directly or indirectly accessible by the CPU 410.

Whether contained in the computer server/CPU 410, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, complied from a language such as “C,” etc.

While the invention has been described in terms of several exemplary embodiments, those skilled in the art will recognize that the invention can be practiced with modification.

While the above-described exemplary embodiments provide approximation functions that approximate business policy functions, Applicant's intent is to encompass the use of any approximation function, which approximates any business policy function. For example, a business policy function may include an inventory optimization function and/or a performance metric optimization function.

A performance metric optimization function may be directed to, for example, a customer satisfaction optimization function, a profit, revenue optimization function, and the like.

Further, it is noted that, Applicant's intent is to encompass equivalents of all claim elements, even if amended later during prosecution.

What is claimed is:

1. A method of generating a business policy, comprising:
receiving a query in a structured query language to generate a business policy; and
generating said business policy using a structured query language program.

2. The method of claim 1, wherein said structured query language program comprises an approximation function that approximates an iterative inventory optimization function.

3. The method of claim 1, wherein said business policy comprises a performance metric.

4. The method of claim 3, wherein said performance metric comprises one of an average inventory level, an inventory level standard deviation, a minimum inventory level, a maximum inventory level, a probability of stock out projection, a fill rate projection, a probability of on time delivery to commit projection, and a probability of on time delivery to request projection.

5. The method of claim 1, wherein said business policy comprises an inventory management policy.

6. The method of claim 5, wherein said inventory policy comprises one of a safety stock, a lot size, a reorder point, a maximum inventory, and a recommended supply quantity.

7. The method of claim 5, further comprising receiving sales transaction data comprising any of a date of origin of a customer order, a requested date for shipment, a requested quantity of items, a customer information, a customer location information, a stocking location, and an item price.

8. The method of claim 5, further comprising receiving operational data comprising an inventory on hand, an inventory on order, a target service level, a safety stock policy, and a lead time data.

9. A system for generating a business policy, comprising:
an enterprise resource planning system;
a data extractor for said enterprise resource planning system; and
a structured query language engine including a structured query language program comprising an objective function for generating said business policy.

10. The system of claim 9, further comprising a structured query language database.

11. The system of claim 9, wherein said structured query language program comprises an approximation function that approximates an iterative inventory optimization function.

12. The system of claim 9, wherein said business policy comprises a performance metric.

13. The system of claim 12, wherein said performance metric comprises one of an average inventory level, an inventory level standard deviation, a minimum inventory level, a maximum inventory level, a probability of stock out projection, a fill rate projection, a probability of on time delivery to commit projection, and a probability of on time delivery to request projection.

14. The system of claim 9, wherein said business policy comprises an inventory management policy.

15. The system of claim 14, wherein said inventory management policy comprises one of a safety stock, a lot size, a reorder point, a maximum inventory, and a recommended supply quantity.

16. The system of claim 14, further comprising receiving sales transaction data comprising any of a date of origin of a customer order, a requested date for shipment, a requested quantity of items, a customer information, a customer location information, a stocking location, and an item price.

17. The system of claim 14, further comprising receiving operational data comprising an inventory on hand, an inventory on order, a target service level, a safety stock policy, and a lead time data.

18. A program embodied in a computer readable medium executable by a digital processing unit comprising:
instructions for receiving a query in a structured query language to generate a business policy; and
instructions for generating said business policy using a structured query language program in said digital processing unit.

19. The program of claim 18, wherein said business policy comprises an iterative inventory optimization function.

20. The program of claim 18, wherein said business policy comprises a performance metric.
